(19) United States
(12) Patent Application Publication
(10) Pub. No.: US 2003/0230681 A1
(43) Pub. Date: Dec. 18, 2003

(54) Self stabilizing structural system

(76) Inventor: Mark W. Gwynneth, Ainslie (AU)

Correspondence Address: Delbert J. Barnard, Barnard Loop & McCormack LLP, P.O. Box 58888, Seattle, WA, 98138, US

(21) Appl. No.: 10/419,562

(22) Filed: Apr. 21, 2003

Related U.S. Application Data
(63) Continuation-in-part of application No. 09/763,426, filed on Feb. 20, 2001, now abandoned.

(51) Int. Cl. F16M 11/24

(52) U.S. Cl. 248/188.3

(57) ABSTRACT

A structure has a first support foot, a second support foot, a third support foot and a fourth support foot. The four support feet are spaced apart. Preferably, the first support foot and the second support foot are fixed feet. The third support foot is vertically adjustable in position and the fourth support foot is vertically adjustable in position. A linkage means is interconnected between the third support foot and the fourth support foot. The linkage means includes lock means associated with the fourth support foot. The third support foot and the fourth support foot are vertically adjustable in position to place them substantially on a support surface together with the first support foot and the second support foot. The linkage means moves the lock means into a locked position in response to the third support foot assuming a predetermined vertical position on the support surface. When locked, the lock means functions to hold the third support foot and the fourth support foot in locked positions substantially on the support surface, so tha thte first the support foot, the second support foot, the third support foot and the fourth support foot are all substantially in contact with the support surface.

### RELATED APPLICATION

This is a continuation-in-part of my application Ser. No. 09/763,426, filed Feb. 20, 2001, and entitled Self Stabilizing System.

### TECHNICAL FIELD

This invention relates to a self-stabilizing structural system. It has particular but not exclusive application to a self-stabilizing and self-locking mechanism for an assembly supported on a surface by a four-based structure of legs or feet. It has particular but not exclusive application to self-stabilizing mechanisms for tables, ladders, stools, trestles, and numerous other four-footed structures, including, but not limited to, all others further identified in this document.

### BACKGROUND INFORMATION

Tables and four-footed structures in general are often subject to uneven supporting surfaces, e.g. floors, causing them to wobble to some degree. Too often the solution involves placing some other form of a shim under one of the four feet. This is an annoyance and is only a temporary solution. This is a problem that needs an effective solution.

Numerous attempts have been made to solve this problem, including those solutions disclosed in the following patents:

Humphreys U.S. Pat. No. 467,811;

Junkunc U.S. Pat. No. 3,117,392;

Whitman U.S. Pat. No. 2,787,087;

Henderson U.S. Pat. No. 3,204,906;

Winters U.S. Pat. No. 5,690,303;

Price Australian Patent No. AU-A-36001/89.

The above patents have proposed solutions for table wobble but in practice, from a stability point of view, these solutions operate similarly to a three-footed structure. Pressure placed from the top down on a corner or on a side of a table, can cause the table to become unbalanced. The proposed solutions of these patents cannot achieve the desired stability and ease of automatic self-adjustment.

Other proposed solutions include those disclosed in the following patents:

Balcar U.S. Pat. No. 2,835,427;

Derby U.S. Pat. No. 2,890,824;

Forristall U.S. Pat. No. 4,095,671.

The systems of these patents are all ladder-leveling systems, with friction binding methods. They have two adjustable legs, requiring two locking mechanisms. While the ladder-type construction may work well for two-footed applications, they are not suitable for four-footed structures. One disadvantage is that one locking mechanism will generally engage before the other, thus creating an imbalance in the final settlement of the four-footed structure.

Other proposed solutions, include those disclosed in the following two patents:

Husted U.S. Pat. No. 2,555,036.

Basile U.S. Pat. No. 3,878,918;

The systems of these patents do not solve the problem, as they are ladder-type constructions that have to be manually locked or unlocked, and generally are not useable on four-footed structures.

The proposed solution by Robinson, Australian Patent No. AU-A-23711/97 is another ladder-type construction. The locking mechanism releases if one leg is lifted off the ground, and further, it is unsatisfactory for a four-footed structure.

Further proposed solutions of ladder type constructions are disclosed in the following patents:

Hopfeld U.S. Pat. No. 3,102,606;

Cook, Sr. U.S. Pat. No. 4,128,139;

Studer U.S. Pat. No. 4,627,516.

The systems of these patents also fall short of the desired solution, as they are ladder-types. Also, because their locking systems are incremental in nature, they will always have a slight degree of wobble if applied to a four-footed structure.

The last solution considered here is a proposed improvement to a four-legged table, in Hickman, Australian Patent No. AU-A-24881/95. Hickman's proposed solution involves two identical leg assemblies that rotate in opposite directions. While this in another fine proposal in theory, it is evidently impractical in real applications.

The primary object of the present invention is to provide an effective solution to the problem that will essentially eliminate all wobble.

### BRIEF SUMMARY OF THE INVENTION

The new self-stabilizing system of the invention is a solution that is effective in all aspects of operation in four-footed structures. This new invention is a built-in, self-stabilizing system that allows automatic adjustment and locking, ensuring all four feet are firmly maintained on the supporting surface. The advantages and benefits of the self-stabilizing system are evident in the unique action of a trigger foot and an adjustable foot. The adjustable foot, once locked into position, will remain locked provided that either the adjustable foot or the trigger foot remains weighted. This enables the self-stabilizing system to behave the same as a rigid four-footed structure even if the table is tilted. This feature also makes the self-stabilizing system suitable for ladders, ensuring that the system stays locked even if weight is removed from either of the two feet. It has been effectively demonstrated that the self-stabilizing system solves the problem of wobble in four-footed structures. The prototypes operate well in providing table stability, ease of use, and effectiveness. Additional benefits, features and aspects of this invention are further described in this document.

The objectives of this invention are as follows:

1. to establish a unique self-stabilizing system for four-footed structures that will adapt itself to even or uneven surface contours;

2. to provide a system of self-stabilization utilizing a completely new technique consisting of a trigger foot, an adjustable foot, and a locking mechanism, whereby the trigger foot initiates the locking action upon the adjustable foot;

3. to provide a self-stabilizing system applicable to numerous four-footed devices of variable size, shape, dimension and function;

4. to provide a means whereby the locking mechanism can be adapted to, and concealed within, a wide variety of conventional support apparatus;

5. to provide a self-stabilizing system where the trigger foot and the adjustable foot can have two different methods of operation: telescopic or pivoting;

6. to provide two types of locking aperture mechanisms that can be applied to different needs and styles of manufacturing: the binding arm with aperture and the trigger foot with aperture;

7. to provide a self-stabilizing system that can be constructed as an internal mechanism or an external mechanism;

8. to provide a self-stabilizing system that can be applied to a support structure in which the trigger leg, adjustable leg, and two fixed legs are elongated;

9. to provide a self-stabilizing system in which there are feet that adjust the structure and which exist within the support structure at the point of contact with the support surface;

10. to provide a self-stabilizing system that produces an effectively rigid four-footed structure;

11. to provide a self-stabilizing system that locks the adjustable foot in precise position relative to the exact degree of adjustment required;

12. to provide a trestle stabilizing system that is robust and easy to manufacture;

13. to provide a self-stabilizing system that offers numerous alternatives and methods of manufacture;

14. to provide the public with a greater choice of alternatives to meet various needs, both household and commercial;

15. to provide a self-stabilizing system that may also be applied to two-footed structures;

16. to provide a self-stabilizing system with greater performance than the previous adjustable leveling devices;

17. to provide greater safety to the public.

Beyond the numerous applications, which are tremendous features, the present invention has other benefits. It is exceptionally easy to use, as the trigger foot and the adjustable foot operate automatically. For example, we will use a basic cafe table to illustrate the superior qualities of the trigger foot system. When placed on a supporting surface, the adjustable foot will extend or retract beyond the height of the fixed feet, and the trigger foot, in contacting the surface, will retract the small amount needed to initiate the locking of the adjustable foot. The mechanism is designed such that the final retraction of the trigger foot equals that of the adjustable foot after locking has been initiated and both fixed feet are already in contact with the supporting surface. The trigger foot always retracts to the same height as the fixed feet. A benefit of this self-stabilizing system is that, once the feet are locked into position, the system effectively behaves the same as a rigid four-footed structure. A benefit and dynamic aspect of this self-stabilizing system is that, if the table is bumped, dragged, pushed, or inadvertently moved, the self-stabilizing system more often than not automatically adapts itself to any variation of surface contour within the range of the adjustable foot. The only variable being that a slight rocking action may have to be applied for the adjustable foot to release its position and re-adjust.

Previous systems do not have the unique combination of trigger foot, adjustable foot, and a locking mechanism initiated by a trigger foot. This self-stabilizing system can be arranged in numerous ways, creating a variety of options and uses. These and other objectives, features, advantages, and benefits of the invention will be more fully evident from the descriptions of the embodiments and the accompanying drawings.

Other objects, advantages and features of the invention will become apparent from the description of the best mode set forth below, from the drawings, from the claims and from the principles that are embodied in the specific structures that are illustrated and described.

### BRIEF DESCRIPTION OF THE SEVERAL VIEWS OF THE DRAWINGS

With the objectives included, further reference is made to the accompanying drawings, illustrating the numerous arrangements, combinations and methods of construction and applications of the invention, and including illustrations of preferred embodiments, wherein:

FIG. 1 is a schematic bottom plan view illustrating the basic principle of support arrangement on a four-footed structure;

FIG. 2 is like FIG. 1 but illustrates the basic principle of support arrangement on a four-footed structure where two sets of self-stabilizing systems are utilized;

FIGS. 3 and 4 are schematic elevational views of a first embodiment illustrating the self-binding principle;

FIGS. 5 and 6 are schematic elevational views of a second embodiment illustrating the two self-binding positions;

FIGS. 7 through 14 are schematic diagrams illustrating the various arrangements of the crank operated binding arm mechanism;

FIGS. 15 through 22 are schematic diagrams illustrating additional arrangements of the crank operated binding arm mechanism;

FIGS. 23 through 30 are schematic diagrams illustrating the various arrangements of the slot operated binding arm mechanism;

FIG. 31 is a sectional view through the center and adjustable foot portion of a third embodiment for a standard pedestal base, with parts shown in elevation;

FIG. 32 is a plan view of the underside of a standard pedestal;

FIG. 33 is a sectional view through the trigger foot portion of the third embodiment, with parts shown in elevation;

FIG. 34 is a perspective view of a bracket utilized in the third embodiment;

FIG. 35 is a sectional view through the center and adjustable foot portion of a fourth embodiment for a slim pedestal base, with parts shown in elevation;

FIG. 36 is a plan view of the underside of a slim pedestal;

FIG. 37 is a sectional view through the trigger foot portion of the fourth embodiment, with parts shown in elevation;

FIG. 38 is a sectional view through the center and trigger foot portion of the fourth embodiment with parts shown in elevation;

FIG. 39 illustrates the slotted actuation bar utilized in the fourth embodiment;

FIG. 40 is a sectional view through the center and adjustable foot portion of a fifth embodiment for an elongated footed pedestal base, with parts shown in elevation;

FIG. 41 is a sectional view through the trigger foot portion of the fifth embodiment, with parts shown in elevation;

FIG. 42 is a plan view of the underside of an elongated legged pedestal incorporating the fifth embodiment;

FIG. 43 illustrates the slotted actuation bar utilized in a sixth embodiment in a corner legged table;

FIG. 44 is a sectional view through two legs and a cross frame of a corner legged table incorporating the sixth embodiment;

FIG. 45 is a perspective view of the corner legged table shown in FIG. 44;

FIG. 46 is a perspective view of a folding table incorporating a seventh embodiment;

FIG. 47 is a sectional view through two legs and a cross frame of the folding table shown in FIG. 46;

FIG. 48 is an elevation view illustrating the lower portion of the legs on one side of a builder's trestle incorporating an eighth embodiment;

FIG. 49 is a schematic perspective view of a builder's trestle;

FIG. 50 is an elevation view illustrating a ninth embodiment with parallel feet pivots;

FIG. 51 is a perspective view of a table with an “inverted T base” utilizing the parallel feet pivot system shown in FIG. 50;

FIG. 52 is a sectional view through the center and adjustable foot portion of a tenth embodiment including a trigger foot with aperture pedestal;

FIG. 53 is a plan view of the underside of the trigger foot with aperture pedestal shown in FIG. 52;

FIG. 54 is a sectional view through the trigger foot portion of the tenth embodiment;

FIG. 55 is a pictorial view of a pedestal base table;

FIGS. 56 through 59 are schematic diagrams illustrating the possible arrangements of the adjustable foot and trigger foot where the foot pivots are at 90 degrees to each other;

FIG. 60 is a pictorial view of an embodiment of the invention which includes both a pivoting foot and a telescopic foot;

FIG. 61 is a sectional view taken substantially along lines 61-61 of FIG. 62, such view showing an embodiment in which the trigger foot is in an arm of a base structure that is perpendicular to the arm which includes the adjustable foot; and

FIG. 62 is a bottom plan view of the mechanism shown by FIG. 61.

### DETAILED DESCRIPTION OF THE INVENTION

### Basic Support Principle for Four-Footed Structure

FIG. 1 is a plan view schematic diagram illustrating the principle arrangement of a four-footed structure on a support surface. The four feet are designated 10, 12, 14, 16. The adjustable foot 10 and the trigger foot 12 are located on the same side of the structure. This applies to all applications of the self-stabilizing system in a four-footed structure. Foot 14 and foot 16 are both fixed relative to the structure. This system provides stabilization only.

### Basic Support Principle for Two Sets of Self-Stabilizing Systems

FIG. 2 is a plan view schematic diagram illustrating the principle arrangement where two sets of self-stabilizing systems are utilized. The locking of adjustable foot 18 is initiated by trigger foot 20, while the locking of adjustable foot 22 is initiated by trigger foot 24. Two sets allow the angle of the structure, relative to the surface it sets upon, to be altered.

### Self-Binding Principle

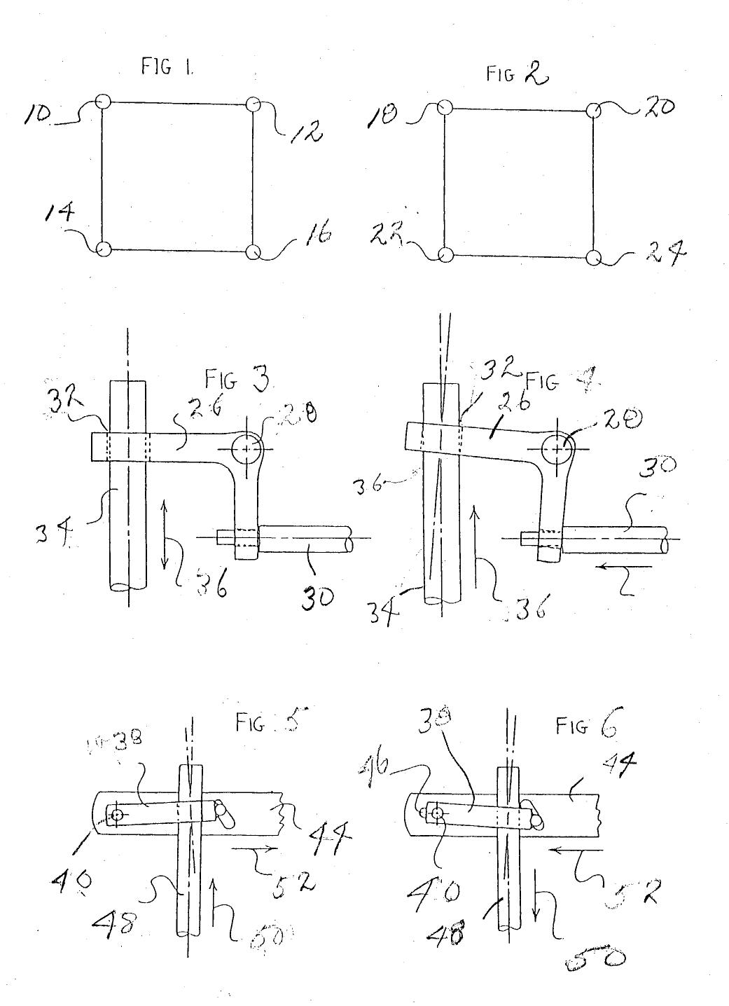

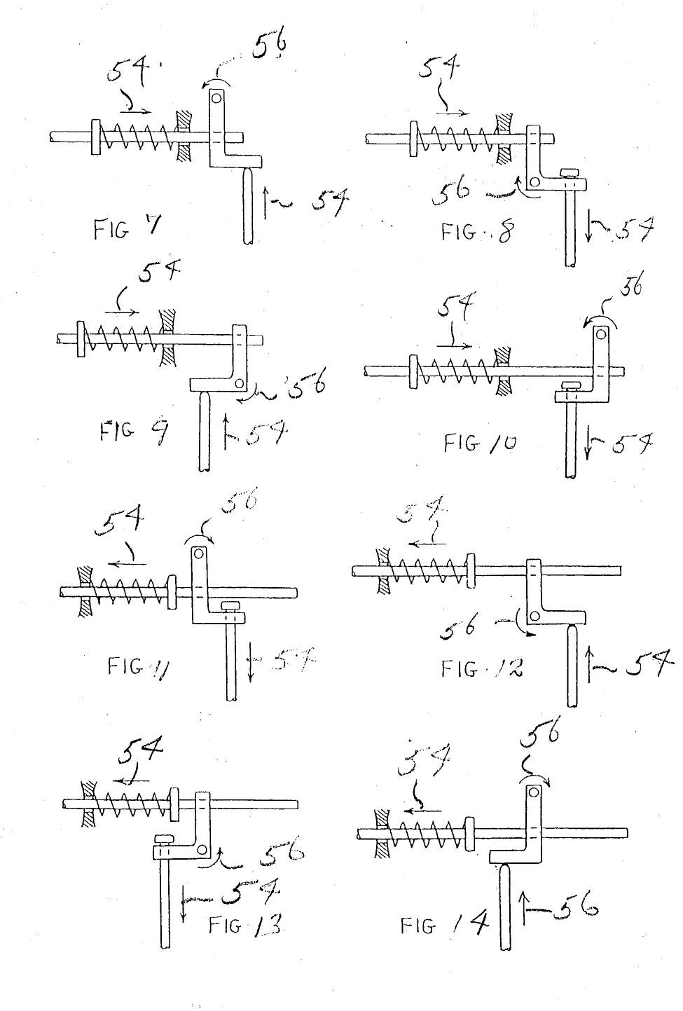

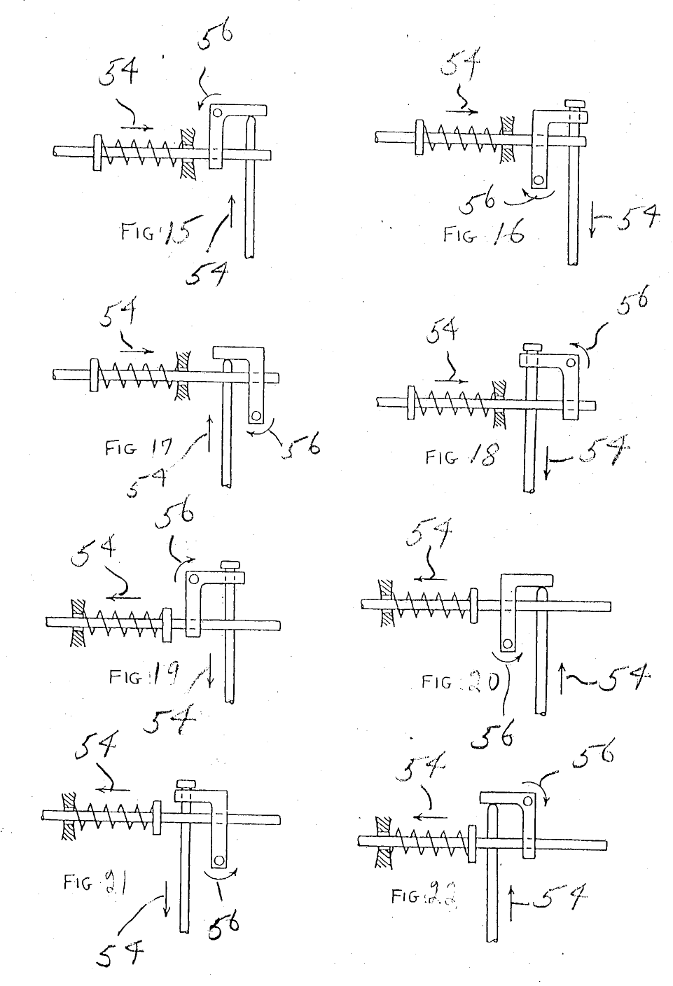

FIGS. 3 and 4 depict a crank-arm version of three basic mechanism arrangements to illustrate the method of friction binding employed to lock the adjustable foot. A binding arm 26 is attached to a structure, not shown, by picot pin 28. A locking rod 30 connects with the adjustable foot, not shown, and passes through an aperture 32 in the binding arm 26. A locking rod 34 is free to slide through the aperture 32, as indicated by arrow 36, when the axis of the aperture 32 and the locking rod 26 are aligned. Retraction of the trigger foot (not shown) causes the trigger rod 30 to move in the direction of arrow 44, slightly rotating the binding arm about pin 28. This causes the axis of the aperture 32 to become non-aligned with the axis of the locking rod 34 and creates the binding action required to prevent movement of the locking rod 34 in the direction of arrow 36.

### Binding on Extension and Binding on Retraction

FIGS. 5 and 6 depict an actuation bar version of three basic mechanism arrangements to illustrate the utilization of the two binding positions of a binding arm 38. The binding arm 38 is attached to a structure (not shown) by a pin 40. An actuation bar 44 is linked to a trigger foot (not shown) and is limited to linear motion by a pin 40 passing through an elongated opening 46. Movement of the actuation bar 44 in the direction of arrow 52 will cause the binding arm 38 to slightly rotate to one of two binding positions and prevent movement of the locking rod 48 in the direction of arrow 50. Movement of the actuation bar ______ in the direction of arrow 52 will prevent movement of the locking rod 48 in the direction of arrow 50. These two binding positions can be utilized to provide binding on extension as well as binding on retraction of the adjustable foot.

### Crank Actuated Binding Arm Arrangements

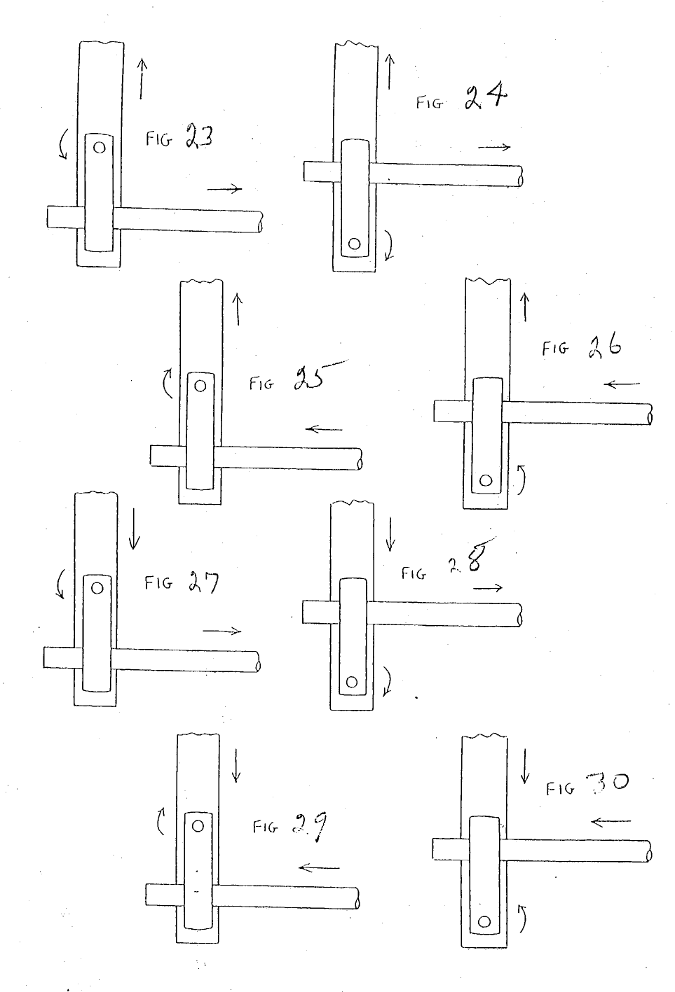

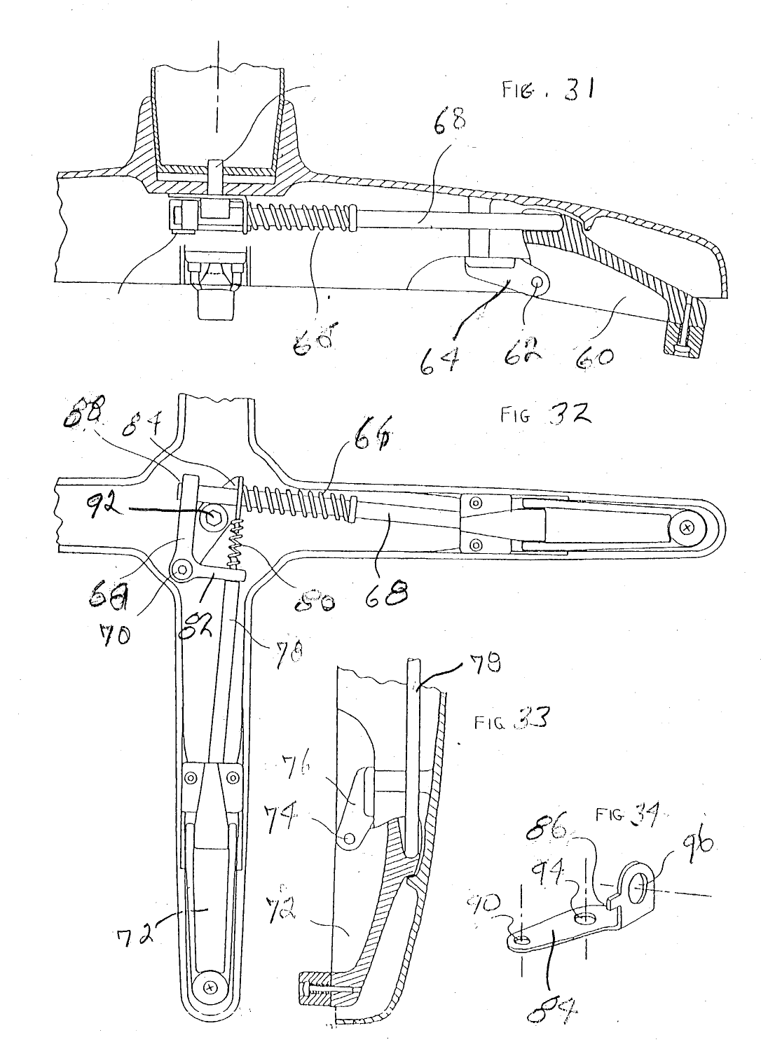

FIGS. 7 through 14 and FIGS. 15 through 22 are schematic diagrams of several crank actuated systems. In FIGS. 7 through 22, the linear and curved arrows 54, 56 indicate the directions in which the components move when systems are being used. The preferred arrangement is depicted by FIG. 9. However, the invention includes all of the arrangements that we illustrated.

### Slot Actuated Binding Arm Arrangements

FIGS. 23 through 30 are schematic diagrams showing various ways that a slot actuated binding arm, a locking rod, and a trigger foot bar can be arranged. The linear and curved arrows 54, 56 indicate the directions in which the components move when the structure is being used. The preferred arrangement is that illustrated in FIG. 26. However, this invention includes all the arrangements that are illustrated.

### Standard Pedestal Base

The preferred mechanism for a standard pedestal base utilizes a crankoperated binding arm of the type shown by schematic FIG. 9, and herein described with reference to FIGS. 31-34. FIG. 31 is a sectional view showing the pedestal center and adjustable foot housing. FIG. 32 is a plan view of the underneath side of the pedestal base. FIG. 33 is a sectional view of the trigger foot housing. FIG. 34 is a three-dimensional view of a bracket.

The adjustable foot 60 pivots on a pin 62, which is located in the pedestal base on a mounting block 64. The adjustable foot 60 is biased to be extended by spring 66, which is located on the locking rod 68. The binding arm 69 pivots on a bolt 70, which is located in the body of the pedestal base. The trigger foot 72 (FIGS. 32 and 33) pivots on a pin 74 which is located in the pedestal base on a mounting block 76. An actuation rod 78 engages with the trigger foot 72 and has a reduced diameter at its inner end for location in the arm 82. Spring 80 is positioned between arm 82 and a member 84 (FIGS. 32 and 34). A tab 86 on member 84 fits into the end of the spring 80. Adjacent member 82, the end of the spring 80 surrounds a reduced diameter portion of the rod 78 which protrudes through an opening in the arm 82. Spring 80 biases arms 82, 68 into the position shown by FIG. 32. In this position, the rod 68 extends through an opening 88 in arm 68, without there being any binding between the arm 66 and the sidewall of the opening 88. Bracket 84 is secured to the pedestal base by a bolt 70 passing through hole 90 (FIG. 34) and by a pedestal post attachment bolt 92 passing through hole 94. Hole or opening 96 (FIG. 34) is for the locking rod 60 to pass through. The fixed feet are not shown in either FIG. 31 or FIG. 32.

### Slim Pedestal Base

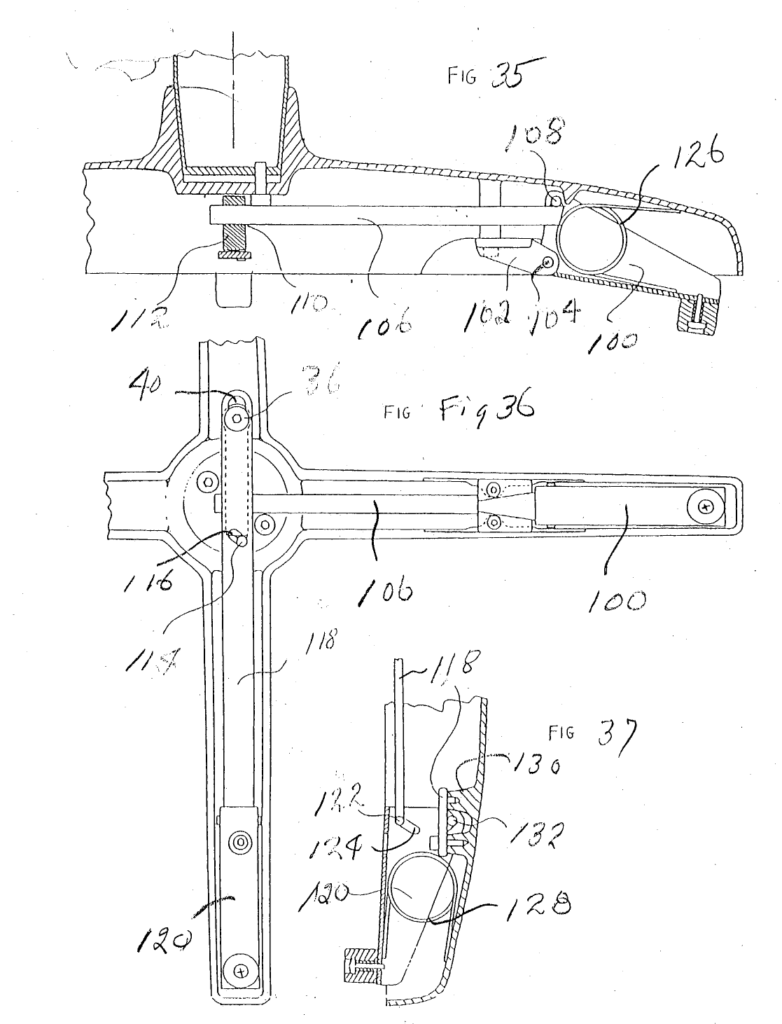

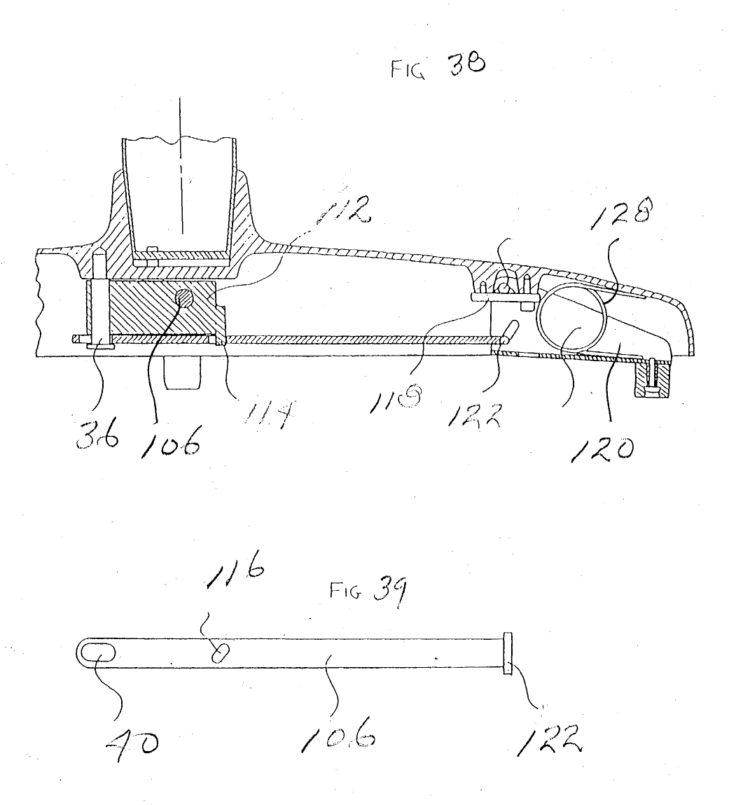

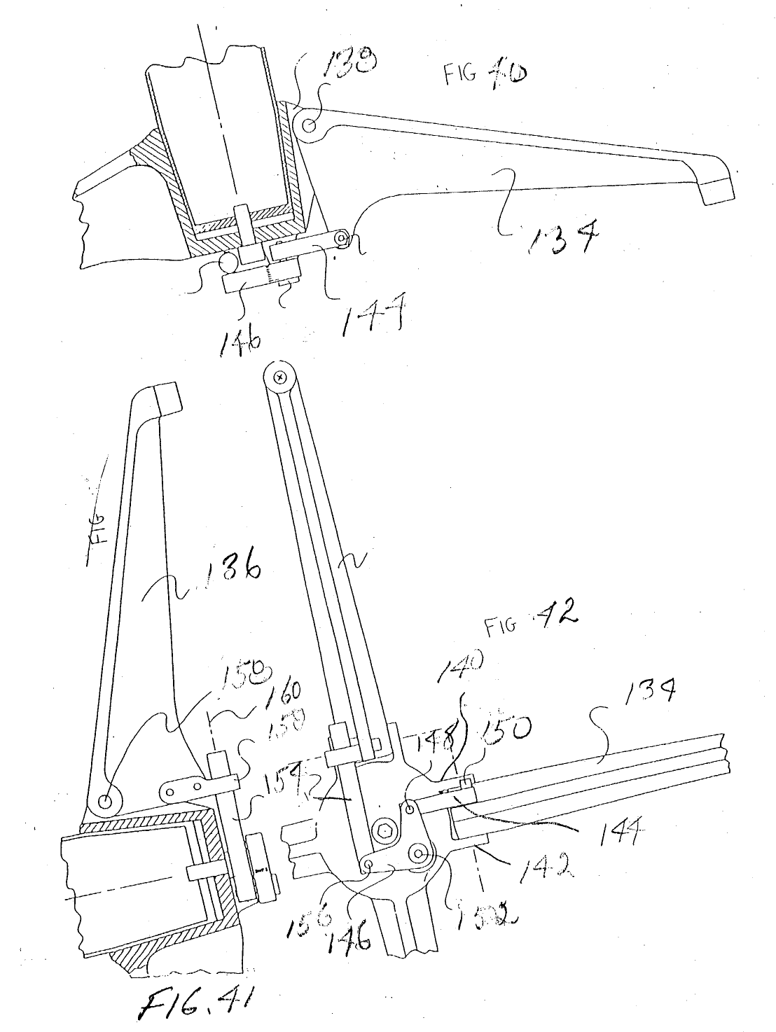

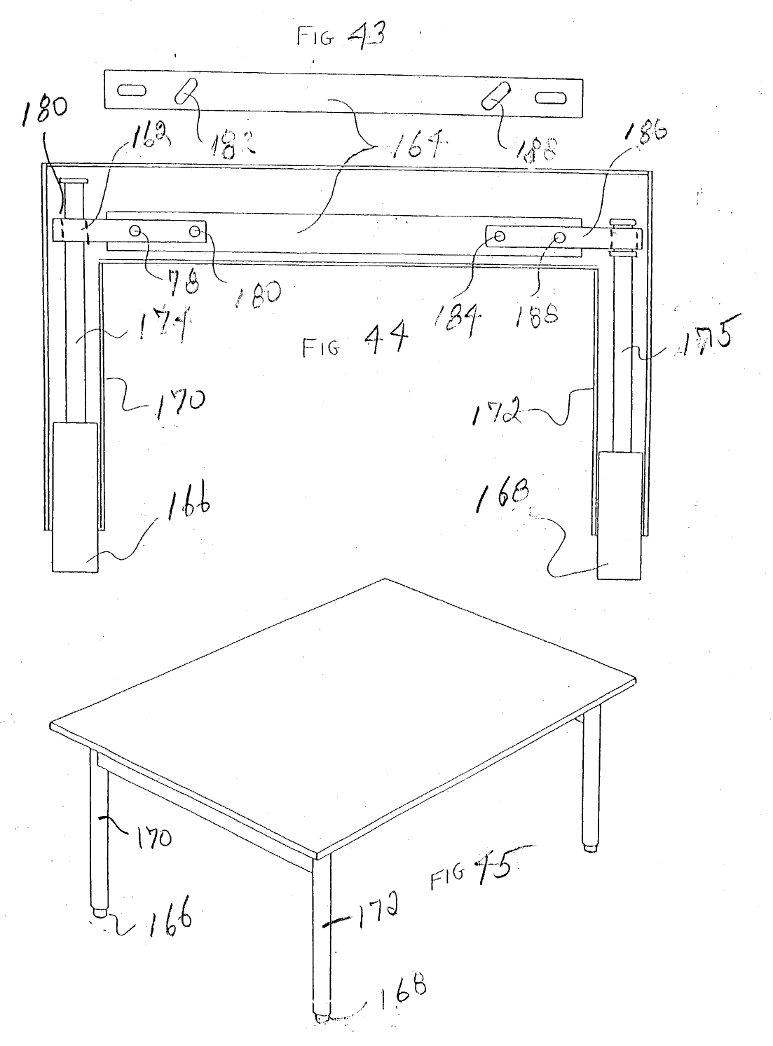

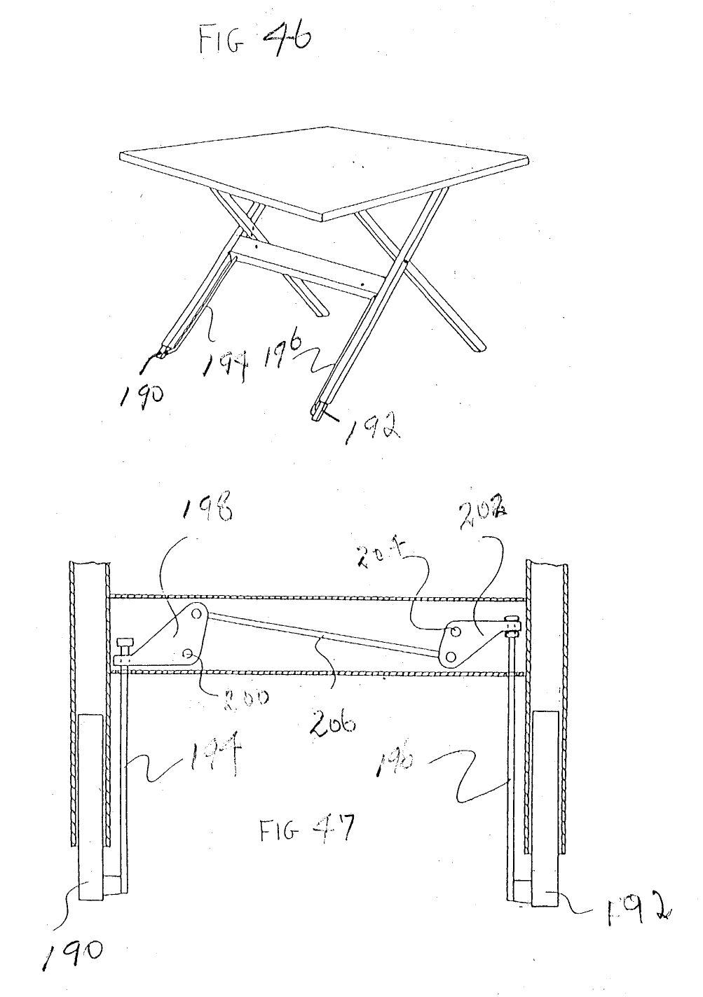

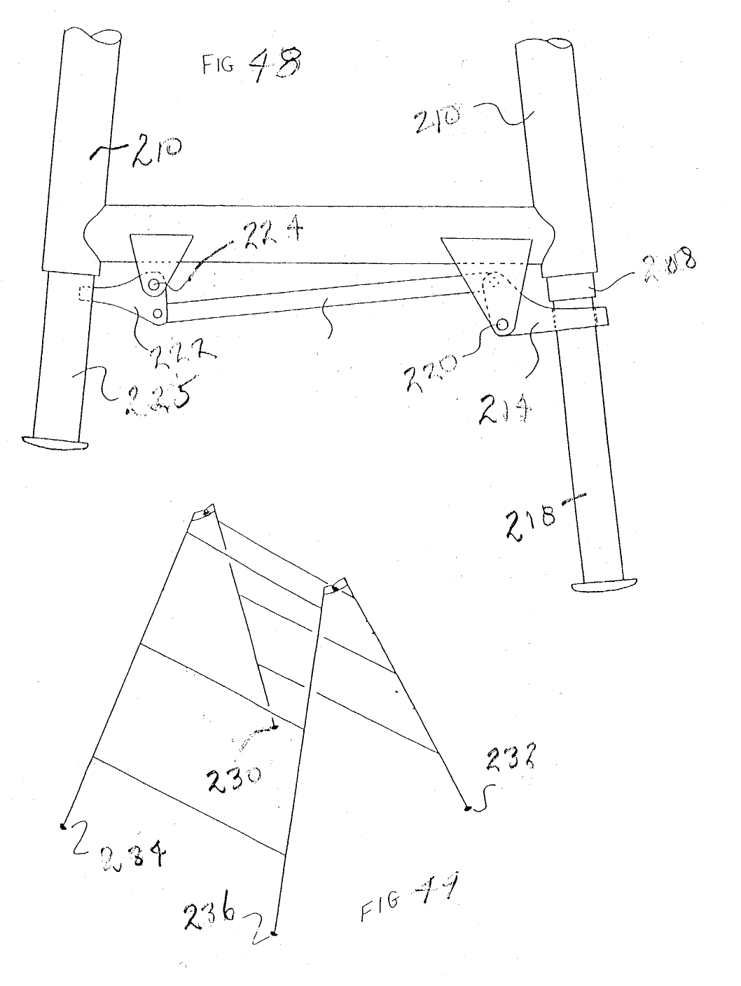

The preferred mechanism for a slim pedestal base utilizes a binding arm activated by a slotted actuation bar, as depicted in schematic FIG. 26, and is herein described with reference to FIGS. 35 through 39. FIG. 35 is a sectional view through the pedestal base showing detail of a locking mechanism and an adjustable foot 100. FIG. 36 is a plan view showing the underside of the base. FIGS. 37 and 38 are sectional views through the trigger foot housing. FIG. 39 shows the actuation bar by itself.

The adjustable foot 100 is mounted to the structure by a bracket 102 (FIG. 35) which contains pivot pin 104. A locking rod 106 is attached to the adjustable foot 100 by a pin 108, which is welded onto the top of the locking rod 106. The locking rod 106 passes through an aperture 110 located in the binding arm 112. The binding arm 112 pivots on bolt 36, which is located in the body of the pedestal base. A pin 114 is attached to the binding arm 112. This pin 114 engages with an angled slot 116 in the actuation bar 118. The actuation bar 118 is located at one end by the binding arm pivot bolt 36, which passes through slot 40. The other end of the actuation bar 118 attaches to the trigger foot 120 by pin 122, which is part of the actuation bar 118. The trigger foot 120 has one round hole and one slotted hole 124 for pin 122 to reside in. The slotted hole 40 is for assembly reasons only and in operation pin 36 remains at the bottom of the slot 40. The two springs 126, 128, one (128) above the adjustable foot 100 and one (128) above the trigger foot (120), bias the feet 100, 120 to extend them upwardly when free to so move. The trigger foot 120 is mounted to the structure by a bracket 130 which has pivot pin 132 welded to it. The fixed feet have not been shown in either FIG. 35 or FIG. 36.

### Pedestal with Elongated Feet

The preferred mechanism for a pedestal with elongated feet utilizes a trigger leg and binding aperture system that is illustrated in FIGS. 40 to 42. With this elongated foot design, the adjustable leg and the trigger leg pivot on pins close to the center of the pedestal. FIG. 40 is a sectional view through the center of the pedestal and the adjustable leg 134. FIG. 41 is a sectional elevation through the center of the pedestal and the trigger leg 132. FIG. 42 is a plan view of the center of the pedestal from underneath. Continuing with reference to these views, the adjustable leg 134 pivots on pin 138 located in the side flanges 140, 142 of the base. A link 144 connects between the adjustable leg 134 and a bell crank 146 by pivots 148 and 150. A bell-crank 146 is attached to the pedestal base by pivot bolt 152. A locking rod 154 is attached to the bell-crank 146 by pin 156 and passes through aperture piece 150, which is secured to the trigger leg. The trigger leg 136 pivots on pin 158 located in the base side flanges. The adjustable leg 134 is free to move when the axis 160 of the aperture 158, located on the trigger leg 136, is aligned with the axis of the locking rod 154. Binding between the trigger leg aperture 158 and the locking rod 154 locks the adjustable leg 134. This is designed to lock when the trigger leg 136 is at the same angle as the fixed legs relative to the pedestal stem.

### Telescopic Legged Table

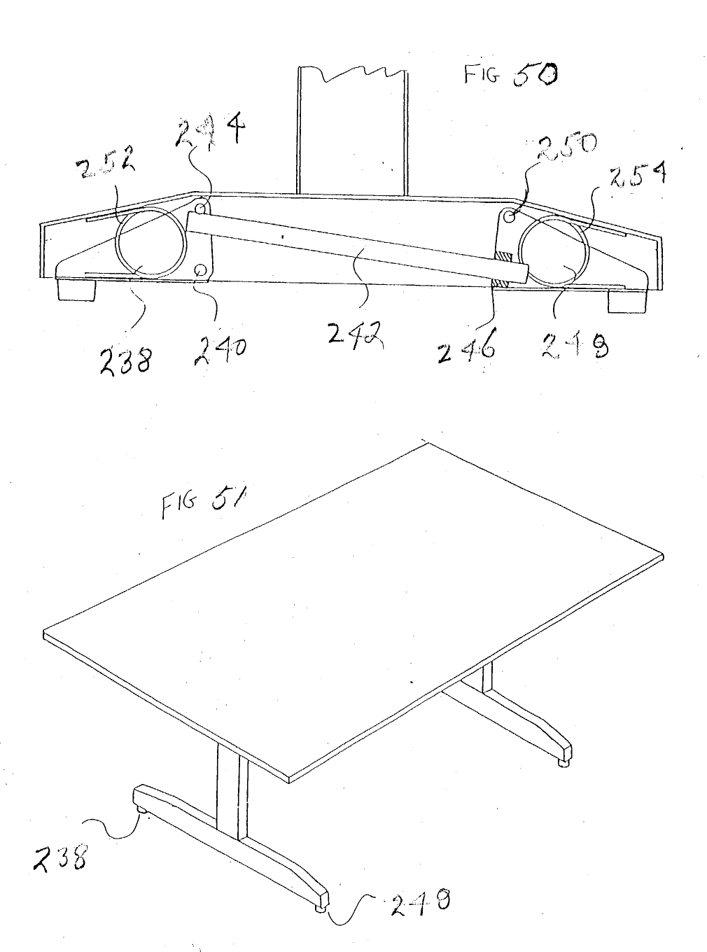

The preferred mechanism for a four-legged table, as depicted in FIG. 45, utilizes a binding arm 162 which is actuated by a slotted bar 164 as illustrated in FIGS. 43 and 44. The adjustable foot 66 and the trigger foot 168 both move longitudinally relative to their respective legs 170 and 172. The locking rod 174 is attached to, or part of, the adjustable foot 166 and is concealed within the leg 170. A trigger foot rod 176 is attached to, or is a part of, the trigger foot 168 and concealed within leg 172. The binding arm 162, attached to the frame by pivot 178, contains an aperture 180 for the locking rod 174 to pass through. A pin 180 engages the binding arm with the actuation bar 164 via slot 182. Another pin 184 engages a lever 186 with the actuation bar 164 via slot 188. The lever 186 is attached to the frame by pivot 188 and connects with the trigger foot rod 175. The actuation bar 164 is located in the frame by pivot 78 and pivot 188 passing through the horizontal slots. Movement of the trigger leg rotates lever 186 and in turn causes linear motion of the actuation bar 164. This linear motion of the actuation bar 164 is transformed back to rotational motion of the binding arm 162. The rotation of the binding arm 162 is limited by the two binding positions of the locking rod 174 in the aperture, locking on extension and locking on retraction.

Alternatively, the binding arm 162 and the lever 186 could both contain crank arms connected with a linkage rod as utilized in the telescopic folding table example listed below.

### Telescopic Folding Table

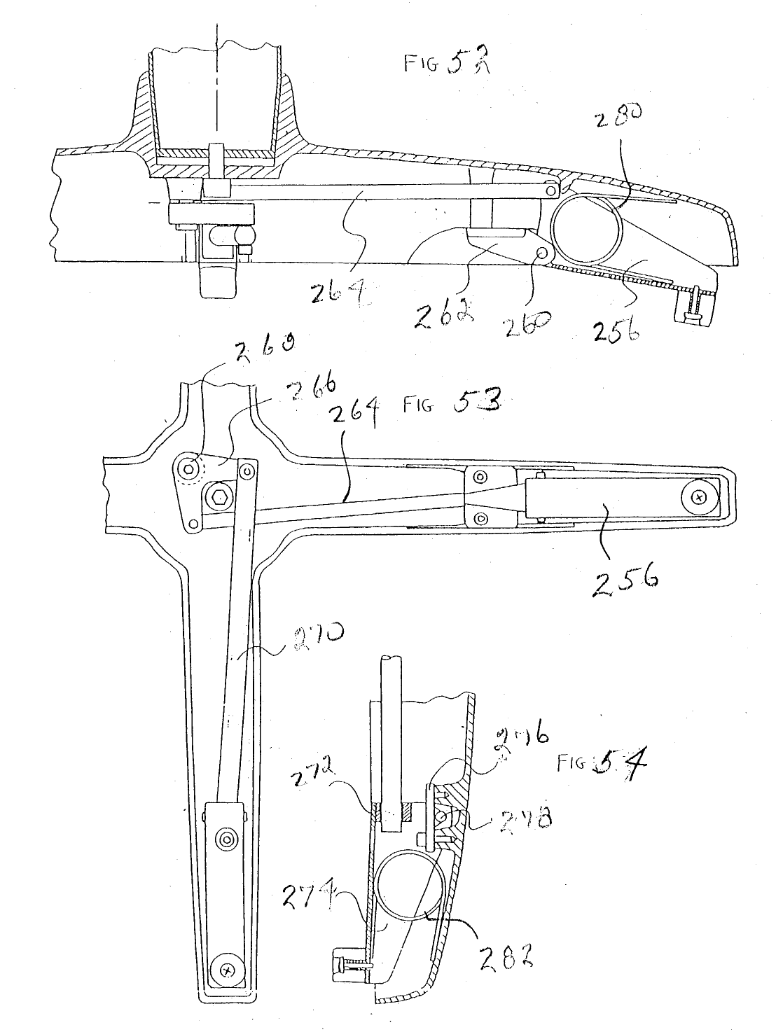

The preferred mechanism for a telescopic folding table, as depicted in FIG. 46, is illustrated in FIG. 47. The adjustable leg 190 and the trigger leg 192 move longitudinally relative to the structure's legs. The locking rod 194 is attached at the bottom of the adjustable leg 190, and the trigger rod 196 is similarly attached to the trigger leg 192. The binding arm 198 is attached to the frame by pivot 200, and lever 202 is attached to the frame by pivot 204. The binding arm and the lever are connected by linkage rod 206.

### Builder's Trestle

The preferred mechanism for a builder's trestle is a telescopic system with an external mechanism as detailed in FIG. 48, which is an elevation view of the lower portion of the trestle showing the self-locking system in detail for one set of the trestle's telescopic legs. In this arrangement the adjustable leg 200, shown at near full extension, also acts as the locking rod. The adjustable leg 208 is a stepped tube, the larger upper section being free to slide inside the tube 210 of the trestle frame, and the smaller lower section 218 being free to slide through an aperture of the binding arm 214 when their axes are aligned. The larger upper diameter 209 serves to limit the extension of the adjustable leg 208. The binding arm 214 is mounted to the trestle frame by pivot 220 and is connected to lever 222 by linkage rod 224. Lever 222 is mounted to the trestle frame by pivot 224 and engages with the trigger leg 225 by having the end of the lever 222 located through a hole in the side of the trigger leg 225. The trigger-leg 225 is free to slide inside the tube 227 of the trestle frame. When the trestle is placed, the adjustable leg 208 retracts until the trigger leg 225 also makes contact with the surface. A small retraction of the trigger leg 225 causes the binding arm 214 to slightly rotate and initiate friction binding of the adjustable leg 218. When the trestle is lifted above a surface, a small extension of the trigger leg 225 moves the locking mechanism to the binding on extension position thus producing a friction locking in the other direction for the adjustable leg 208 and preventing it from dropping down.

The system may be applied to one or two sets of the trestle's legs. Application to one set of legs provides stabilization only, while application, to two sets of legs allows the level of the trestle to be adjusted relative to the surface it is placed upon. In both applications, the locking of the adjustable leg is automatic. FIG. 49 is a sketch of a trestle showing the position of two sets of self-locking systems. The lower ends of all four legs are telescopic. Leg 230 triggers the locking of adjustable leg 232, while leg 234 triggers the locking of adjustable leg 236.

### Parallel Feet Pivots with Trigger Foot Aperture

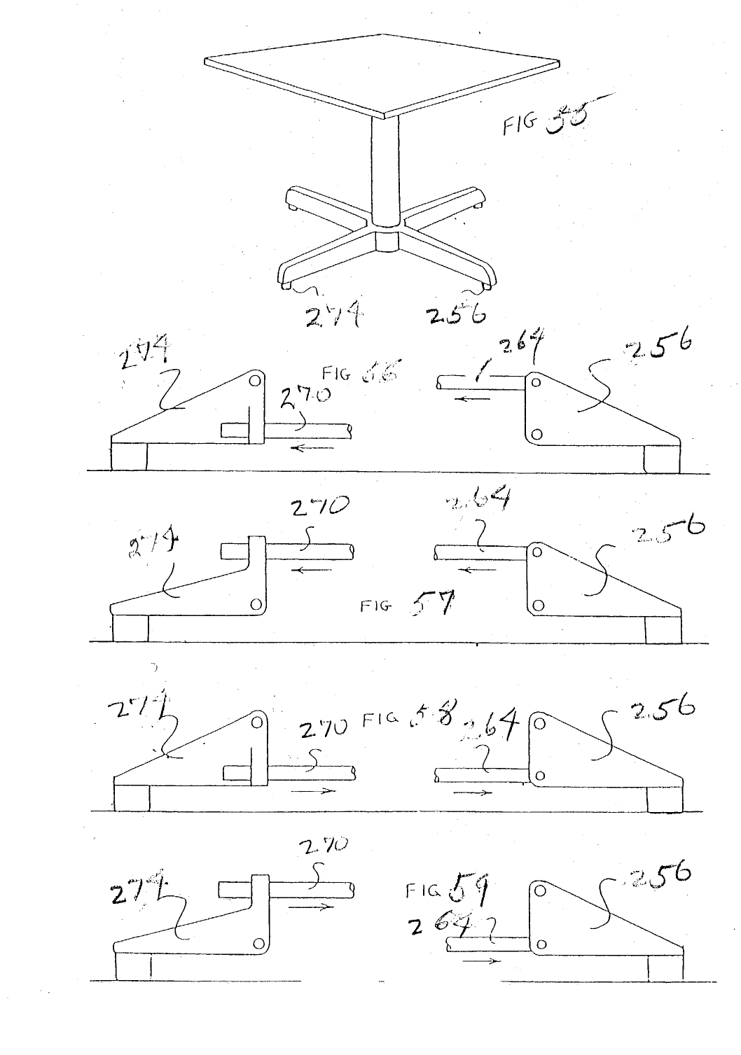

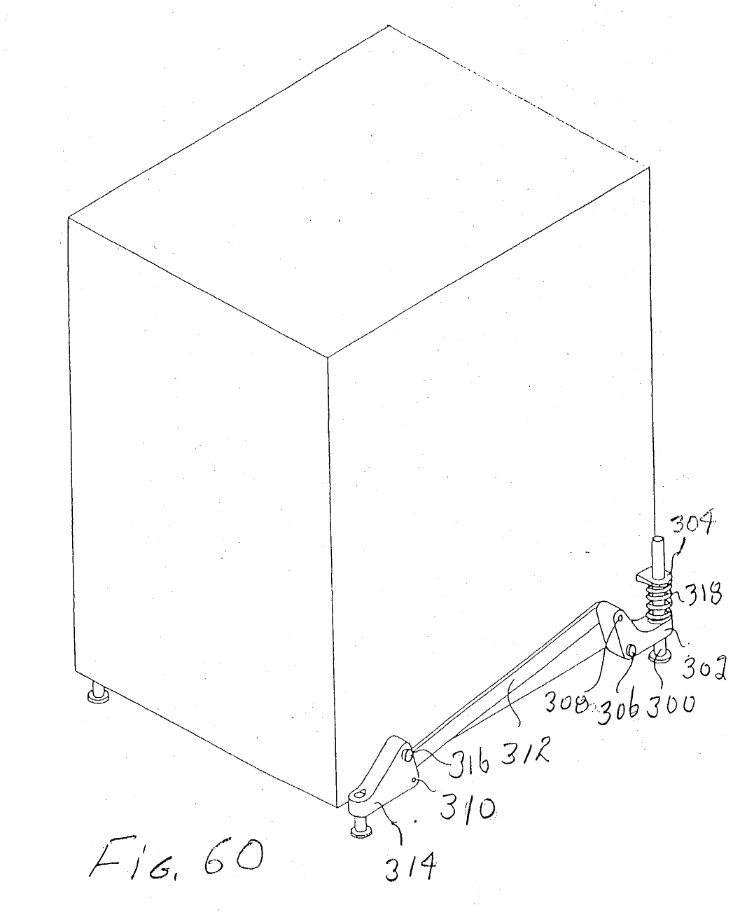

This version of the self-stabilizing system has the locking aperture and trigger foot combined, and the adjustable foot pivot is parallel with the trigger foot pivot. It has a wide range of applications, but for ease of description, the ‘inverted-T-style’ table base, FIGS. 50 and 51, is utilized to illustrate the mechanism arrangement. The adjustable foot 238 is attached to the structure by pivot 240. The locking rod 242, connected to the adjustable foot by pivot 244, passes through the locking aperture 246 in the trigger foot 248. The trigger foot 248 is attached to the structure by pivot 250. Gravity or springs 252 and 254 may be utilized to bias both the adjustable foot 238 and the trigger foot 248 to extend when free to do so. Free from a surface, the trigger foot 248 extends until the locking mechanism is in the binding on extension position. When being placed upon a surface, the trigger foot 248 retracts until the locking mechanism moves to the binding on retraction position. Between these two locking positions, the locking rod 242 is free to pass through the aperture 246, permitting the adjustable foot 238 to extend if necessary. The adjustable foot can extend much further than the trigger foot, the latter's rotation being limited to a relatively small amount by the clearance between the locking rod and the aperture.

The same mechanism layout, but placed in a different structure, may be applied for stabilizing various structure or appliances such as washing machines and refrigerators.

### Trigger Foot Aperture with Feet Pivots at 90 Degrees

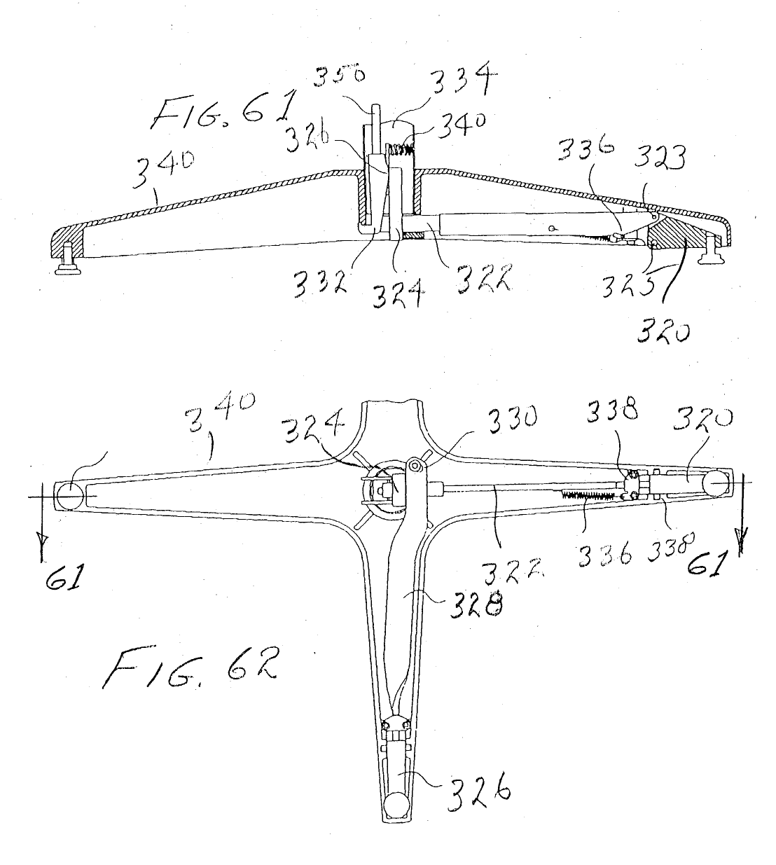

The preferred mechanism for a pedestal base with trigger foot aperture is detailed with reference to FIGS. 52 to 54. This arrangement utilizes the configuration of trigger foot and adjustable foot as depicted in FIG. 56. FIG. 52 is a sectional view showing the pedestal center and adjustable foot housing. FIG. 53 is a plan view of the underneath side of the pedestal base. FIG. 54 is a sectional view of the trigger foot housing. The adjustable foot 256 pivots on pin 260, which is located in the pedestal base on a mounting block 262. A linkage rod 264 connects the adjustable foot 250 with a bell-crank 266 located near the center of the pedestal base by pivot bolt 268. Locking rod 270 is connected to the bell-crank 266 and passes through locking aperture 272, which is part of trigger foot 274. The trigger-foot 274 is mounted to the structure by bracket 276, which has pivot pin 278 welded to it. Two springs, one (280) above the adjustable foot and one (282) above the trigger foot 274, bias the feet to extend when free to do so. The fixed feet have not been shown in any of these figures. FIGS. 56 through 59 are alternative ways in which the trigger foot 274 and adjustable foot 256 can be arranged.

### Pivoting/Telescopic Arrangement

The preferred mechanism for white goods appliances, such as washing machines, dryers and refrigerators, is detailed in FIG. 60.

FIG. 60 is a pictorial view with a cut-away showing the location of the pivoting/telescopic mechanism. The actual structural piece that the mechanism attaches to has not been drawn.

This arrangement utilizes a pivoting trigger foot, a binding arm aperture, and a telescopic adjustable leg. The adjustable leg 300, which doubles as the locking rod, passes through the locking aperture in the binding arm 302 and also through the locking rod guide 304 that is fixed to the structure. The binding arm is located by pivot 306 that attaches to the structure. Pivots 308, 310 connect a linkage bar 312 between the binding arm and the trigger foot 314. The trigger foot 314 is located by pivot 316 that attaches to the structure. A spring 318, located on the locking rod, biases the system to binding an extension of the adjustable foot when non-engaged with a surface. Contact of the trigger foot 310 with a surface moves the binding arm against the spring force to cause binding on retraction of the adjustable leg 300. When the binding arm 302 moves through between the two binding positions, the adjustable leg 300 is free to either extend under gravity or retract as it contacts the floor.

The mechanism would be placed at the rear of the appliance and conventional glides could be placed at the two front corners to provide the means for manual leveling. To operate the stabilizing mechanism, the appliance would be tilted onto the front glides to allow the stabilizing mechanism to release itself, and then back causing the adjustable foot to retract until the trigger foot makes contact and initiates the locking action.

### Pivoting/Telescopic Arrangement

The preferred mechanism for white goods appliances, such as washing machines, dryers and refrigerators, is detailed in FIG. 60.

FIG. 60 is a pictorial view with a cut-away showing the location of the pivoting/telescopic mechanism. The actual structural piece that the mechanism attaches to has not been drawn.

This arrangement utilizes a pivoting trigger foot, a binding arm aperture, and a telescopic adjustable leg. The adjustable leg 300, which doubles as the locking rod, passes through the locking aperture in the binding arm 302 and also through the locking rod guide 304 that is fixed to the structure. The binding arm is located by pivot 306 that attaches to the structure. Pivots 308, 310 connect a linkage bar 312 between the binding arm and the trigger foot 314. The trigger foot 314 is located by pivot 316 that attaches to the structure. A spring 318, located on the locking rod, biases the system to binding an extension of the adjustable foot when non-engaged with a surface. Contact of the trigger foot 310 with a surface moves the binding arm against the spring force to cause binding on retraction of the adjustable leg 300. When the binding arm 302 moves through between the two binding positions, the adjustable leg 300 is free to either extend under gravity or retract as it contacts the floor.

The mechanism would be placed at the rear of the appliance and conventional glides could be placed at the two front corners to provide the means for manual leveling. To operate the stabilizing mechanism, the appliance would be tilted onto the front glides to allow the stabilizing mechanism to release itself, and then back causing the adjustable foot to retract until the trigger foot makes contact and initiates the locking action.

### Scope of Invention

The scope of this invention applies generally to all types of embodiments that could be devised and operable as or within any four-footed structure employing the self-stabilizing system, including but not limited to:

tables and benches;

washing machines and dryers;

refrigerators and freezers;

trestles and scaffolding;

filing cabinets and floor cabinets;

ladders and any indoor or outdoor apparatus.

### Summary

This invention provides an alternative and an improvement to known systems and methods for self-stabilizing tables, trestles, and other four-footed structures. The invention exists as a stabilizing assembly and, when placed on any surface, even or uneven, is self-adjusting and self-stabilizing. It can be built into a plurality of supports, meaning two out of four legs/feet in a typical table, or most four-legged structures. In a four-footed structure, it has two fixed feet, an adjustable foot, and a trigger foot. Its uniqueness is a result of the principle of its action, consisting of an adjustable foot, a means of locking the adjustable foot, and a trigger foot that initiates the locking action upon the adjustable foot.

The locking action, in general, occurs when the axis of the locking rod and the axis of the aperture arm become non-parallel to each other, creating a friction-binding action.

In operation, the four-footed structure settles onto the two fixed feet first and then the adjustable foot will extend or retract beyond the height of the fixed feet, and the trigger foot, in contacting the surface, will retract the small amount needed to initiate the locking of the adjustable foot. The mechanism is designed such that the final retraction of the trigger foot equals that of the adjustable foot after locking has been initiated and both fixed feet are already in contact with the surface. The trigger foot always retracts to the same height as the fixed feet. A benefit of this self-stabilizing system is that, once the feet are locked into position, it effectively behaves the same as a rigid four-footed structure.

In addition, or summarize in greater detail, the ratio of leverage on the locking mechanism by the adjustable foot in relation to that of the trigger foot is designed such that the final retraction of the adjustable foot equals that of the trigger foot, beginning when the locking action commences and the structure (table) is being secured in place, with the two fixed feet already firmly in contact with the surface. This is further clarified in the description section of this document.

In the claims, the “adjustable foot” is referred to as the “third support foot.” The “trigger foot” is referred to as the “fourth support foot.”

The illustrated embodiments are only examples of the present invention and, therefore, are non-limitive. It is to be understood that any changes in the particular structure, materials and features of the invention may be made without departing from the spirit and scope of the invention. Therefore, it is my intention that my patent rights not be limited by the particular embodiments illustrated and described herein, but rather are to be determined by the following claims, interpreted according to accepted doctrines of patent claim interpretation, including use of the doctrine of equivalents and reversal of parts.

What is claimed is:

1. A self-stabilizing system for a structure having a first support foot, a second support foot; a third support foot; and a fourth support foot, said support feet being spaced apart;
said third support foot being vertically adjustable in position and said fourth support foot being vertically adjustable in position;
linkage means interconnected between the third support foot and the fourth support foot and including lock means associated with the fourth support foot;
said third support foot and said fourth support foot being vertically adjustable in position to place them substantially on a support surface together with the first support foot and the second support foot; and
said linkage means moving the lock means into a locked position in response to the third support foot assuming a predetermined vertical position on the support surface, said lock means when locked functioning to hold the third support foot and the fourth support foot in locked positions substantially on the support surface, so that the first support foot, the second support foot, the third support foot and the fourth support foot are all substantially in contact with the support surface.

2. The stabilizing system of claim 1, wherein the third support foot is a pivoting adjustable foot, and the fourth support foot is a pivoting adjustable foot, and said linkage means includes a locking rod connecting to the third support foot and a pivoting binding member connected to the fourth support foot, said binding member including an opening in which the locking rod is received, and wherein pivotal movement of the binding member will cause frictional binding at the aperture of the binding member and the locking rod, for locking the third and fourth support feet together.

3. The self-stabilizing system of claim 1, wherein the fourth support foot includes an aperture and the linkage means includes a locking rod connected to the third support foot, said locking rod extending from the third support foot to and through the aperture in the fourth support foot, wherein the locking rod and the aperture constitute the locking means and locking is achieved by frictional binding of the locking rod and the aperture when the third and fourth support feet are both in contact with the support surface.

4. The self-stabilizing system of claim 1, wherein the third support foot and the fourth support foot are elongated members and each reciprocate lengthwise.

5. The self-stabilizing system of claim 4, wherein the third support foot includes a locking rod and the linkage means comprises a pivoting binding member including an aperture sized to receive the locking rod, and the binding member is connected to the fourth support foot and when the third and fourth support feet are both contacting the support surface the binding member is pivoted into a position in which the binding piece is locked to the locking rod by frictional binding of the locking rod in the aperture, and the linkage means locks the third support foot to the fourth support foot, with both the third support foot and the fourth support foot being in contact with the support surface, together with the first and second support feet.

6. The self-stabilizing system of claim 1, wherein the first and second support feet are fixed feet.

7. The stabilizing system of claim 6, wherein the third support foot is a pivoting adjustable foot, and the fourth support foot is a pivoting adjustable foot, and said linkage means includes a locking rod connecting to the third support foot and a pivoting binding member connected to the fourth support foot, said binding member including an opening in which the locking rod is received, and wherein pivotal movement of the binding member will cause frictional binding at the aperture of the binding member and the locking rod, for locking the third and fourth support feet together.

8. The self-stabilizing system of claim 6, wherein the fourth support foot includes an aperture and the linkage means includes a locking rod connected to the third support foot, said locking rod extending from the third support foot to and through the aperture in the fourth support foot, wherein the locking rod and the aperture constitute the locking means and locking is achieved by frictional binding of the locking rod and the aperture when the third and fourth support feet are both in contact with the support surface.

9. The self-stabilizing system of claim 6, wherein the third support foot and the fourth support foot are elongated members and each reciprocate lengthwise.

10. The self-stabilizing system of claim 9, wherein the third support foot includes a locking rod and the linkage means comprises a pivoting binding member including an aperture sized to receive the locking rod, and the binding member is connected to the fourth support foot and when the third and fourth support feet are both contacting the support surface the binding member is pivoted into a position in which the binding piece is locked to the locking rod by frictional binding of the locking rod in the aperture, and the linkage means locks the third support foot to the fourth support foot, with both the third support foot and the fourth support foot being in contact with the support surface, together with the first and second support feet.

11. The self-stabilizing system of claim 1, wherein the structure has an elongated first leg including the first support foot, an elongated second leg including the second support foot, an elongated third leg including the third support foot and an elongated fourth leg including the fourth support foot

12. The self-stabilizing system of claim 11, wherein the third leg has a tubular upper portion and the third support foot is a lower portion of the third leg that is telescopically received in the upper portion, and the fourth support leg has a tubular upper portion and the fourth support foot is a lower portion of the fourth leg that is telescopically received in the upper portion of the fourth leg.

13. The self-stabilizing system of claim 12, wherein the four legs are substantially parallel to each other.

14. The self-stabilizing system of claim 13, wherein the third support foot and the fourth support foot are parallel, elongated members and each reciprocate lengthwise.

15. The self-stabilizing system of claim 14, wherein the third support foot includes a locking rod and the linkage means comprises a pivoting binding member including an aperture sized to receive the locking rod, and the binding member is connected to the fourth support foot and when the third and fourth support feet are both contacting the support surface the binding member is pivoted into a position in which the binding piece is locked to the locking rod by frictional binding of the locking rod in the aperture, and the linkage means locks the third support foot to the fourth support foot, with both the third support foot and the fourth support foot being in contact with the support surface, together with the first and second support feet.

16. A self stabilizing system as an assembly operating within or as a four footed structure having two fixed feet, comprising an adjustable foot, a means of locking the adjustable foot, and a trigger foot that initiates the locking action of the adjustable foot where both the adjustable foot and the trigger foot are existing on one side of the four footed structure, and the two fixed feet are existing on the other side of the four footed structure; and the ratio of leverage on the means of locking by the adjustable foot in relation to the trigger foot is such that a final retraction of the adjustable foot equals that of the trigger foot, beginning when locking action of the means of locking commences and the structure is being secured in place, with the two fixed feet already firmly in contact with a surface, thereby when placed on the surface, the adjustable foot will extend or retract beyond the height of the fixed feet, and the trigger foot, in contacting the surface, will retract a small amount needed to initiate locking o the adjustable foot; and the trigger foot always retracts to the same height as the fixed feet.
